(19) United States
(12) Patent Application Publication
(10) Pub. No.: US 2008/0274315 A1
(43) Pub. Date: Nov. 6, 2008

(54) Laminated Film And A Fluid Dispenser Including Such A Film

(75) Inventors: Frederic Duquet, Thibouville (FR); Herve Pennaneac'h, Piseux (FR)

Correspondence Address: SUGHRUE MION, PLLC, 2100 PENNSYLVANIA AVENUE, N.W., SUITE 800, WASHINGTON, DC, 20037, US

(73) Assignee: VALOIS SAS, Le Neubourg (FR)

(21) Appl. No.: 11/720,568

(22) PCT Filed: Dec. 5, 2005
(86) PCT No.: PCT/FR05/51034

§ 371 Date: Feb. 25, 2008

(30) Foreign Application Priority Data
Dec. 7, 2004 (FR) 0452882

(51) Int. Cl. B32B 27/32; B32B 15/08; B32B 27/08

(52) U.S. Cl. 428/35.2; 428/35.3; 428/35.4; 428/35.8; 428/35.9

(57) ABSTRACT

A fluid dispenser comprising a fluid reservoir (CO), a portion of the reservoir being formed by a laminated film (O; O′) defining a front face (A) and a rear face (B) and comprising a plurality of layers (1, 2, 3, 4, 5, 6, 7; 1′, 2′, 3′, 4′, 5′, 6′, 7′), a front layer (1; 1′) forming the front face (A) and a rear layer (7; 7′) forming the rear face (B), the front layer (1; 1′) being transparent and comprising a sealing material, such that the laminated film can be sealed to another element, the dispenser being characterized in that one of the layers, other than the front layer (1; 1′), is a front decorative layer (2; 2′) that is visible through the front layer (1; 1′), the fluid, and the reservoir.

The present invention relates to a laminated film that defines a front face and a rear face and that comprises a plurality of superposed layers. The present invention also relates to a fluid dispenser using such a laminated film, in particular as a closure membrane, so as to co-operate with another element, e.g. a profiled shell, to make a fluid reservoir. Thus, the laminated film of the invention finds an advantageous application as a closure membrane, but it can also be used for other applications such as packaging or labeling, for example. Such a laminated film can be used in numerous technical fields, and in particular in the fields of perfumery, cosmetics, or even pharmacy.

Numerous multilayer laminated films have been on the market for some time. Some laminated films are transparent, while others are completely opaque. To make a film opaque, it is possible to use a barrier layer so as to prevent light from passing therethrough, for example. Aluminum is a material that is frequently used for the barrier layer. Other types of barrier layer for providing a screen against the passage of other elements or radiation can also be used, such as SiOx, for example. Some laminated films are for coming into direct contact with a substance, preferably a fluid, namely a liquid or a powder. However, solid materials are not excluded. The laminated film must thus be as neutral and as inert as possible in the presence of that substance. In general, that type of laminated film comprises at least one barrier layer and a plurality of plastics-material layers. In addition, laminated films are also known that are used as labels for affixing to an article. Labels serve to display instructions of any kind, namely written or diagrammatic. Labels can also present a decorative element for improving the appearance of the article. The decoration or the readable inscriptions are generally provided by a print layer that is applied to another layer that is often designated under the term flat tint. For a label, the print layer is the outermost layer that is in contact with ambient air. In general, the print layer can be designated using the term “decorative layer” even though it can include written instructions.

That type of label is not adapted to be used as a closure membrane for coming into direct contact with a substance, in particular a fluid. The decorative layer uses print materials such as ink that are not compatible with some substances, and in particular with perfume. Consequently, it is not possible to use such labels as closure membranes for forming or finishing off perfume reservoirs.

An object of the present invention is to define a laminated film, in particular that is usable as a closure membrane for a reservoir for fluid, e.g. perfume, and that presents the same esthetic advantages as a label presenting visible decoration. Another object is to make a dispenser for dispensing fluid, such as perfume, that has decoration that is visible through the fluid.

To do this, the present invention provides a fluid dispenser comprising a fluid reservoir, a portion of the reservoir being formed by a laminated film defining a front face and a rear face and comprising a plurality of layers, a front layer forming the front face and a rear layer forming the rear face, the front layer being transparent and comprising a sealing material, such that the laminated film can be sealed to another element, the dispenser being characterized in that one of the layers, other than the front layer, is a front decorative layer that is visible through the front layer, the fluid, and the reservoir. The front layer thus covers the front decorative layer, such that it does not constitute the front face of the laminated film. In other words, the front layer covers and protects the front decorative layer. The front layer may advantageously be made of polyethylene terephthalate (PET). However, other materials may be used, in particular those known for being inert relative to certain substances. However, PET is preferable, since it can also provide heat-sealing with another element, such as a profiled reservoir shell, for example.

According to one of the characteristics of the invention, one of the layers is a barrier layer.

Advantageously, the barrier layer is transparent and is interposed between the front decorative layer and the front layer, such that the front decorative layer is visible through the front layer and the barrier layer. The barrier layer is preferably made of SiOx.

In a variant, the barrier layer is made of aluminum.

In this event, the barrier layer is opaque, and the front decorative layer is thus interposed between the barrier layer and the front layer.

According to another characteristic of the invention, one of the layers is a rear decorative layer that is visible from the rear face. The laminated film is thus decorated on both of its faces, such that decoration is visible both from the front face and from the rear face.

In an embodiment of the invention, the front decorative layer is a print layer that is applied to the rear face of the front layer. The front face of the front layer constitutes the front face of the laminated film.

By means of the invention, a laminated film is obtained having decoration on both faces, with the decoration of the front face being protected by an inert front layer.

The reservoir is advantageously formed by: a transparent shell that defines a deformable actuator wall that can be pressed so as to reduce the working volume of the reservoir; and a closure membrane that is fastened in leaktight manner to the shell so as to define between them the reservoir, the closure membrane being formed by the laminated film.

The shell is preferably made of transparent PET, the shell comprising a portion that is convex and that is surrounded by a peripheral portion that is plane, the laminated film that serves as a closure membrane being heat-sealed to the shell via the plane peripheral portion. The decoration of the closure membrane can thus be seen through the transparent shell, the transparent or translucent fluid, and the front layer.

The laminated film of the invention thus serves both as a closure membrane for finishing off a fluid reservoir, and as a double-sided label that is completely inert relative to the fluid stored in the reservoir.

Reference is made below to the accompanying drawings which show two embodiments of the invention by way of non-limiting example.

In the figures:

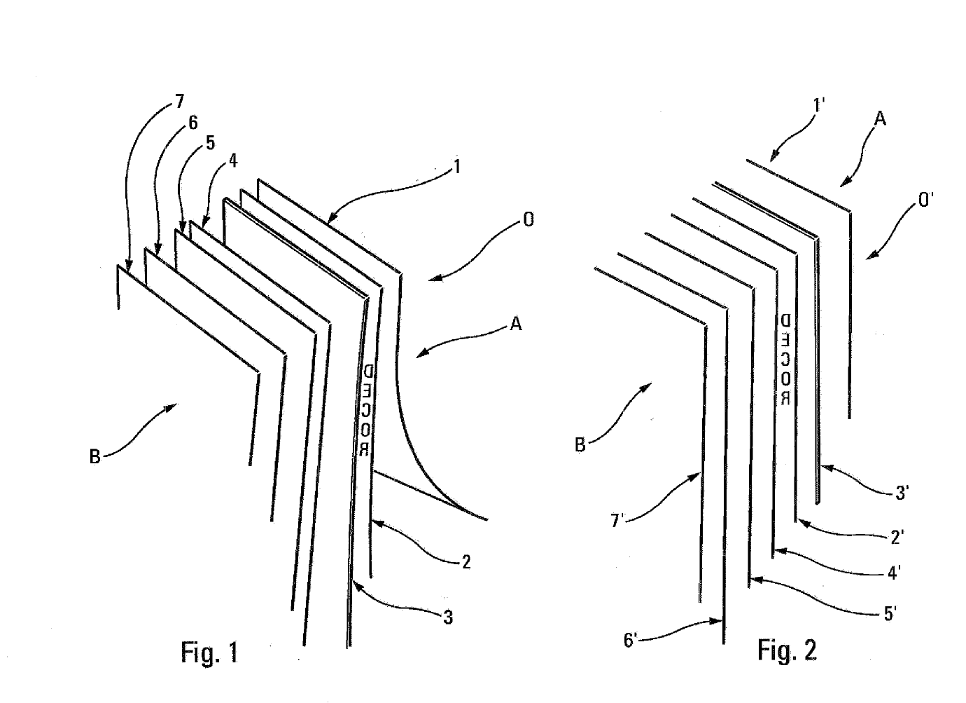

FIG. 1 is a diagrammatic perspective view of a laminated film constituting a first embodiment of the invention;

FIG. 2 is a view similar to the view in FIG. 1 constituting a second embodiment of the laminated film of the invention;

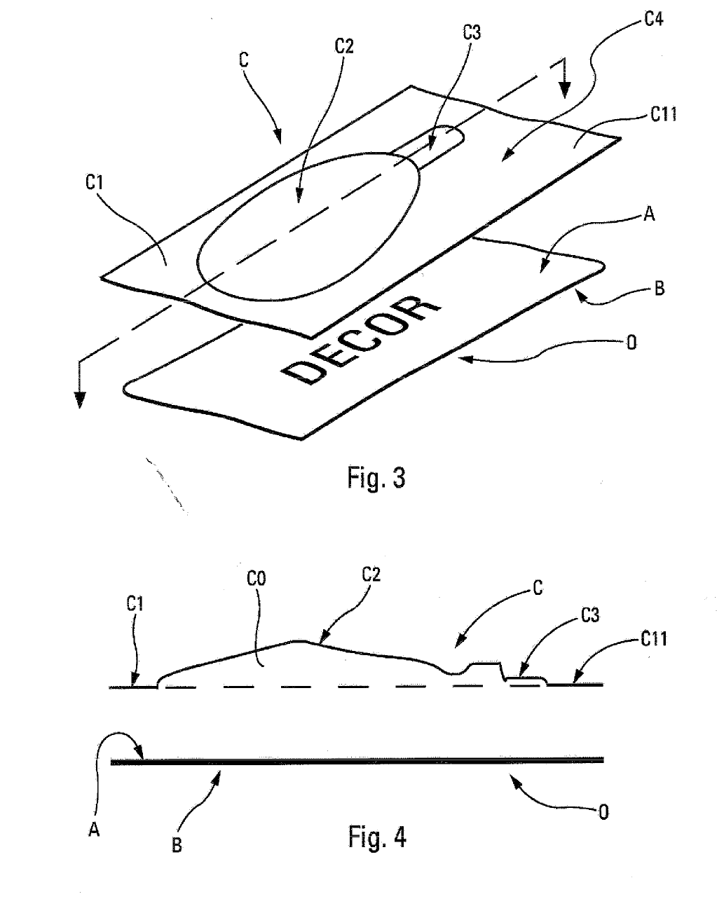

FIG. 3 is a diagrammatic exploded view in perspective showing a fluid dispenser using a laminated film of the invention; and

FIG. 4 is a vertical section view through the FIG. 3 dispenser.

With reference firstly to FIG. 1, which shows a first embodiment of the invention, it can be seen that the laminated film, that is designated overall by the letter O, comprises seven successive superposed layers that are designated by numeric references 1 to 7 starting from the front face A and ending at the rear face B. In this embodiment, the various layers are represented diagrammatically as plane sheets, but it should be clearly understood that some of the layers are not constituted by plane sheets, but merely by printing or a localized deposit. However, for the purpose of clarity of the drawings, all of the layers, even if they exist only as fragments are shown as plane sheets. In addition, the layers are not necessarily plane.

Starting from the front face A, the laminated film O firstly includes a front layer 1 that can be made of PET, for example, with a thickness of about 30 micrometers (μm). The front layer 1 serves as an outer layer, and its outside front face defines the front face A of the laminated film. The layer 1 can also advantageously serve as a layer for bonding to another element by adhesive or heat-sealing as described below. The front layer 1 is advantageously transparent or at least translucent. The second layer, referenced 2, is a print or decorative layer that can be applied directly to the rear face of the front layer A. In reality, the front decorative layer 2, represented diagrammatically in FIG. 1 as a sheet, is constituted by printing representing decoration and/or characters. It is even possible that the layers 1 and 2 form a single layer only, with the rear face of the front layer being provided with decoration. The third layer, referenced 3, is a barrier layer that can be made of aluminum, for example, with a thickness of about 15 μm. The front layer 1 with its front decorative layer 2 is applied to the barrier layer 3, and is bonded to the barrier layer 3 by any known technique. For example, it is possible to use adhesive or heat-sealing techniques. The laminated film of the invention can be constituted by no more than these three layers 1, 2, and 3. The decorative layer 2 is thus visible through the front layer 1.

However, in the invention, this primary type of three-layer laminated film can be provided with a rear decoration that can be constituted by four successive layers referenced 4 to 7, for example. The layer 4 is an adhesion primer layer that is applied to the barrier layer 3. The layer 5 is a flat tint onto which the layer 6, constituting a rear text or decorative layer, is applied. Finally, the optional layer 7 is a protective layer, e.g. a layer of varnish. The outside face of the protective layer 7 constitutes the rear face B of the laminated film O.

FIG. 2 shows a variant embodiment for the laminated film, which, in this embodiment, is designated by the reference O′. The laminated film O′ also includes a front layer 1′ having a front face that constitutes the front face A of the laminated film. The front layer 1′ can also be made of PET with a thickness of about 30 μm. The second layer that is in contact with the front layer 1′ is a barrier layer 3′, which, in this embodiment, is made of SiOx. The SiOx can be deposited directly on the front layer 1′. The distinctive feature of the SiOx barrier layer is that it is transparent. Behind the barrier layer 3′ is a front decorative layer 2′, which, in this embodiment, is represented by a sheet, but which, in reality, is merely a layer of localized printing. The front decorative layer 2′ can be identical to the front decorative layer 2 in FIG. 1. Given that the SiOx barrier layer is transparent, the front decorative layer 2′ is visible through the barrier layer. Since the front layer 1′ is transparent like the front layer 1 in FIG. 1, it is thus possible to see the decoration formed by the layer 2′ through the barrier layer 3′ and the front layer 1′. The front decorative layer 2′ can be applied to a support layer 4′. In practice, once provided with its front decoration 2′, the supporting or flat-tint layer 4′ is applied to the barrier layer 3′ and bonded in place by any known techniques, e.g. by adhesive or heat-sealing. The laminated film could be limited to layers 1′, 2′, 3′, and 4′. However, in the example shown in the figures, the laminated film O′ also includes three other layers 5′, 6′, and 7′ that serve to provide decoration that is visible from the rear face B. Specifically, the rear decorative layer 6′ that is applied to its support layer 5′ that is bonded to the support layer 4′. A protective layer 7′ is optionally applied to the layer 6′.

In the two embodiments in FIGS. 1 and 2, the front decorative layer 2 or 2′ does not constitute the front face A of the laminated film. On the contrary, the front face A is formed by a front layer 1 or 1′ that serves both as a protective layer for protecting the decoration, and advantageously as a sealing layer for sealing to another element. The front layer 1 or 1′ is preferably transparent, or at least translucent, such that the decoration formed by the front decorative layer 2 or 2′ is visible through the front layer 1 or 1′.

It is thus possible to use the laminated film O or O′ as a closure membrane for forming or finishing off a reservoir containing a substance, in particular a fluid such as perfume, for example. Reference can be made to FIGS. 3 and 4 which are exploded views showing a dispenser for dispensing a fluid, and more particularly a perfume. The dispenser comprises two component elements, namely a shell C and a closure membrane O. The shell C can advantageously be made by a technique of thermoforming plastics material. The plastics material can be PET. The shell C comprises a convex portion C2 that forms a deformable actuator wall that is pressed by means of a finger so as to deform the convex portion. The actuator wall advantageously presents resistance to deformation and/or an elastic shape memory that returns the wall to its original position. The convex portion C2 is associated with an outlet portion C3 that is also made in relief. The portions C2 and C3 are surrounded by a peripheral portion C1 that is plane. The outlet portion C3 has a tear line or a line of weakness C4 passing therethrough that defines a tear-off tab portion C11 that forms an integral part of the plane peripheral portion C1. The closure membrane O can be made from the above-described laminated film O or O′. The front face A faces the shell C, whereas the rear face B constitutes the rear face of the dispenser. The closure membrane is applied to the shell C and is heat-sealed thereon via the substantially plane portion C1. Heat-sealing is effective given that it is performed between two elements of the same kind, i.e. made of PET. The front layer forming the front face A of the closure membrane O is a layer made of PET, while the shell C is also made of PET. Heat-sealing the closure membrane O over the plane portion C1 of the shell C results in a fluid reservoir C0 being made, defined between the convex portion C2 and the closure membrane O. Given that the shell C is transparent, it is possible to see the decoration formed by the front decorative layer 2 or 2′ directly through the reservoir, and more particularly through the shell C of the reservoir. It is thus possible to provide decoration, that is not in contact with the fluid, that makes it possible to disguise or to mask the convex portion C2 of the shell C, that does not always present an attractive appearance. It is thus possible to use the front decorative layer of the closure membrane to give dispensers a shape that is other than the shape of the concave portion C2 of the shell.

By means of the invention, a laminated film is obtained that is decorated and completely inert.

1. A fluid dispenser comprising a fluid reservoir (CO), a portion of the reservoir being formed by a laminated film (O; O′) defining a front face (A) and a rear face (B) and comprising a plurality of layers (1, 2, 3, 4, 5, 6, 7; 1′, 2′, 3′, 4′, 5′, 6′, 7′), a front layer (1; 1′) forming the front face (A) and a rear layer (7; 7′) forming the rear face (B), the front layer (1; 1′) being transparent and comprising a sealing material, such that the laminated film can be sealed to another element, the dispenser being characterized in that one of the layers, other than the front layer (1; 1′), is a front decorative layer (2; 2′) that is visible through the front layer (1; 1), the fluid and the reservoir.

2. A dispenser according to claim 1, in which one of the layers is a barrier layer (3; 3′).

3. A dispenser according to claim 2, in which the barrier layer (3′) is transparent and is interposed between the front decorative layer (2′) and the front layer (1′), such that the front decorative layer is visible through the front layer and the barrier layer.

4. A dispenser according to claim 2, in which the barrier layer (3′) is made of SiOx or of aluminum.

5. A laminated film according to claim 2, in which the barrier layer (3) is made of aluminum.

6. A dispenser according to claim 1, in which the front layer (1; 1′) is made of PET.

7. A dispenser according to claim 1, in which one of the layers is a rear decorative layer (6; 6′) that is visible from the rear face (B).

8. A dispenser according to claim 1, in which the front decorative layer is a print layer that is applied to the rear face of the front layer.

9. A dispenser according to claim 1, in which the reservoir is formed by:
a transparent shell (C) that defines a deformable actuator wall (C2) that can be pressed so as to reduce the working volume of the reservoir; and
a closure membrane that is fastened in leaktight manner to the shell so as to define between them the reservoir, the closure membrane being formed by the laminated film (O; O′).

10. A dispenser according to claim 9, in which the shell (C) is made of transparent PET, the shell comprising a portion (C2) that is convex and that is surrounded by a peripheral portion (C1) that is plane, the laminated film (O; O′) that serves as a closure membrane being heat-sealed to the shell via the plane peripheral portion.
